(19) United States
(12) Patent Application Publication
(10) Pub. No.: US 2003/0122514 A1
(43) Pub. Date: Jul. 3, 2003

(54) Unitary trifunctional door manager and method

(75) Inventors: Patrick M. Mercier, Gibsonia, PA (US); Thomas P. Schluep, Mars, PA (US)

Correspondence Address: William L. Krayer, 1771 Helen Drive, Pittsburgh, PA, 15216, US

(73) Assignee: B.E.A. Holdings, Inc.

(21) Appl. No.: 10/315,833

(22) Filed: Dec. 10, 2002

Related U.S. Application Data
(60) Provisional application No. 60/339,185, filed on Dec. 11, 2001.

(51) Int. Cl. H02P 1/00

(52) U.S. Cl. 318/280; 340/541

(57) ABSTRACT

Three door managing functions, motion detection, presence detection, and image monitoring are coordinated with safety features in a single compact housing for a door. Two or more of the units may be coordinated.

### RELATED APPLICATION

This application incorporates and claims the full benefit of Provisional Application No. 60/339,185 filed Dec. 11, 2001.

### TECHNICAL FIELD

This invention relates to automatic door openers and particularly to a device which controls the opening and closing of a door as a function of motion in a field of surveillance as well as presence in a field of surveillance, and also provides a discreet camera for monitoring events in a field of surveillance, with optional activation of a recording device.

### BACKGROUND OF THE INVENTION

Various types of controls have been proposed for door opening and closing based on infrared or microwave detection. Video cameras are also well known as security devices for stores, office buildings and factories, banks, museums and other businesses and institutions.

The industry is constantly striving to improve such devices and installations. There is a need for an efficient way to coordinate the opening and closing of the door with actual crossing of a threshold, and with the recording of events which may lead to litigation. A compact system which will not only constantly provide appropriate automatic openings and closings of a door but which will also provide coordinated records of the door threshold and area. Such records can limit fraudulent claims and lead to lower insurance premiums, and is therefore desirable in the industry.

### SUMMARY OF THE INVENTION

Our invention combines three functions: (1) activation—that is, opening and/or closing of the door, based upon detected motion (2) safety—maintaining the door in an open or safe state, based on detected presence which may not be moving, and (3) image, recorded or not, which may be continuous or intermittent based on activation or safety input. The three functions are coordinated at least in that they all focus on a common area. Preferably they are housed in a compact, conveniently and discreetly installed housing.

The first function, activation, is accomplished preferably by a microwave transmitter and a receiver (preferably combined in a transceiver) capable of detecting motion by analysis of the received (reflected) microwaves by the Doppler effect. As is known in the art, the frequency of a transmitted wave will be altered on reflection from an object if it is moving. We prefer to use a combined transmitter and receiver in a transceiver. The activation function (opening the door, for example) is implemented when motion is detected as a phase shift and/or a change in frequency in the reflected microwave radiation. A transceiver unit may be referred to as an active unit, as contrasted to a passive device such as a passive infrared device, which is designed to detect motion, for example, only by received infrared energy rather than transmission and reflection. Other types of motion detectors may be based on a passive infrared device or an ultrasound system. Any motion detector capable of generating an electrical signal when motion is detected may be used in our invention, but we prefer a microwave transceiver. The activation function may be manifested also as closing the door when there is no motion, although, as explained later herein, the closing signal may be overridden by the safety function.

The second function, safety, is accomplished by infrared reflection or absorption to detect the presence of objects such as humans, particularly when they are immobile and vulnerable to being hit by a moving door. An infrared transceiver is used for this purpose; the device will detect a change in the infrared radiation pattern from the scrutinized area, and generate an electrical signal as a function of the difference. A suitable ultrasonic transceiver may also be used in place of the infrared transceiver if the user desires.

The third function, imaging, is accomplished by a small image detector, or camera, preferably mounted in the same container or box as the motion and presence detectors. The camera has a lens focused on a common area also under surveillance by the motion and presence detectors. The lens projects onto a chip which converts the image to electrical signals. The image is relayed to a remote monitoring station and/or a recording station, either or both of which may operate continuously or intermittently; preferably the recorder will include a time/date imprint on the record. While the image is created continuously, recording may be controlled to activate only when there is an object in the surveillance area.

Our preferred system comprises (a) a microwave transceiver for motion detection, (b) an infrared transceiver for presence detection, and (c) at least one discreet video camera, all coordinated to monitor substantially the same space including space on both sides of a door. Surveillance, i.e. sensing, of substantially the same space by all three functions is accomplished by placing the three devices in substantially the same location, preferably in the same housing above the door. Moreover, the invention is designed to monitor the space not only in front of the door but directly through the entranceway and for a desired distance on the other side. The method of the invention therefore comprises the correlation of input representing all three functions.

### BRIEF DESCRIPTION OF THE DRAWINGS

FIGS. 1a and 1b are perspective views of a housing and its contents for a unitary door operator of our invention.

FIGS. 2a and 2b are simplified sketches of the overlapping sensing areas employed in a preferred variation of our invention having two unitary trifunctional overhead devices.

FIG. 3 is a box diagram of the interconnections of our invention.

FIG. 4 is a planar antenna that is preferred for use in the microwave motion detector.

### DETAILED DESCRIPTION OF THE INVENTION

As indicated above, we employ three types of sensing devices in a common housing: a motion detector, a presence detector, and a discreet camera, all coordinated to monitor a common area.

As stated in the Summary of the Invention, for motion detection, we prefer to use a microwave transceiver. The microwave transceiver preferably employs K band frequencies, preferably in the range 24.05 GHz to 24.25 GHz, but any suitable frequencies may be used. It will continuously transmit microwaves within the K band range onto the designated area and will receive reflections from the area. Microwaves reflected from a moving object will be analyzed by the receiver as having a frequency different from the transmission (a higher frequency moving toward the transceiver and a lower frequency moving away) as is known in the art. Either deviation from the original frequency is analyzed electronically as motion, in circuitry, in a chip, or by an algorithm, as in a separate microprocessor. A control unit then generates a signal causing the door to open. A similar signal causing it to close is generated when there is no longer any motion, or at a predetermined interval after motion has ceased. Suitable motion detectors include VG087, Eagle and Wizard, all trademarks of B.E.A., Inc..

In addition to being able to detect motion more or less indiscriminately, our device is able to determine the direction of movement of an object in the surveillance area. The microwave transmitter transmits signals of the same frequency which are 90 degrees out of phase; reflections are analyzed electronically or by appropriate algorithms to determine slight positive or negative changes in phase, providing a basis for determining direction. This may be useful to building owners who may wish to maintain a door in the open position for a shorter time when motion is in one direction in preference to the other. Our device may also utilize inputs as to movement interpreted as entering the building as contrasted to movement seen as exiting the building. Various controls may be implemented to open, close, and/or maintain the current position of the door depending on the building owner's desires.

Microwave transmissions can be used in any other safe frequency range, such as X band, preferably 10.5 to 10.55 GHz. The user will want to be aware of government regulations and to possible restrictions on radar emissions in certain frequency ranges, interferences, and power restrictions. X band frequencies may not be as sensitive to slow motion as K band frequencies. In addition, X band can sometimes interfere with cell phone and other communications. As a substitute for radar, we may use ultrasonic transmissions. Ultrasonic transceivers are also available commercially and known to persons skilled in the art. In addition, we may use an infrared transceiver as a motion detector. The infrared system emits infrared radiation into the target area and receives reflections which vary when there is motion in the area. Suitable devices include Crystal, Iris, Activ8, and Wizard, all trademarks of devices made by BEA, Inc. Either the ultrasonic or the infrared motion detector can trigger the generation of a control signal for opening the door in the same manner as the microwave motion detector described above. A passive infrared system may also be used, preferably with a Fresnel lens, to detect motion.

The emissions of any of the microwave, ultrasonic or infrared devices may be continuous, pulsed, or controlled in any other effective manner..

Presence detection is preferably accomplished by an active infrared detector. Active infrared detectors (including IR transmission) are well known in the art.

The camera, sometimes called herein a video camera or an imaging device, is preferably small and unobtrusive, i.e. discreet and difficult to notice in the housing. We prefer an analog camera having a composed video output.

The control system is integrated in such a way that the microwave signal will open the door when motion is detected in the sensing area; the door will remain open as long as there is a signal representative of motion in the sensing area. The door also will remain open as long as presence is detected by the infrared transceiver. Thus a signal representing presence, derived from the infrared sensor, may override a control signal from the microwave sensor indicating that there is no longer any motion in the sensing area, which normally would close the door, so that if a pedestrian falls down and is motionless, for example, the door will not close on him or her. The video camera may be operational continuously, particularly if it is connected to a remote manned screen monitoring station. However, recording need not be conducted continuously—that is, a digital or other recording device may be caused to operate only when the door is activated. Any commercial recorder such as a tape recorder, analog or digital recorder, may be used, whether continuously operated or not. As soon as the door opener is activated, the recorder may be switched on by the same electrical signal, and recording may be terminated when the door is completely closed. The camera may be turned on and off in the same manner, at the discretion of the owner.

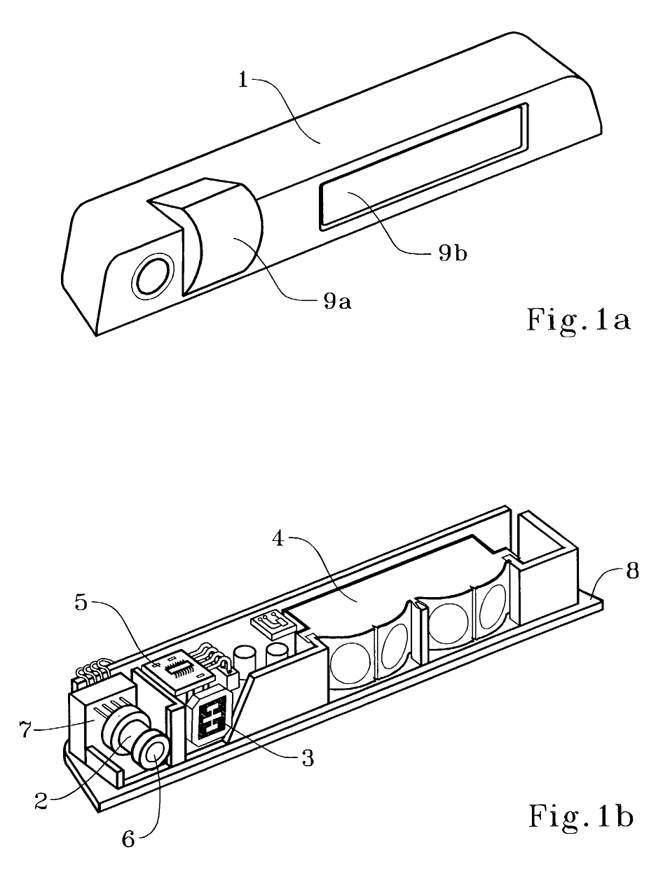

Referring now to the diagram of a preferred compact configuration of FIGS. 1a and 1b, cover 1 may be removed to show the position and relative size of the camera 2, microwave transceiver 3, and infrared transceiver 4, each of which may be as described above and mounted on a base 8. The microwave transceiver includes an antenna of a design adapted for the area to be monitored, and is further described with respect to FIG. 5. The infrared transmitter also is focused on at least a part of the same area monitored by the microwave. And, the camera is equipped with a lens 6 that is directed towards at least a part of the same area. Behind the lens 6 is a chip 7 for obtaining the image and transmitting it through connections not shown, as further described elsewhere herein. The unitary trifunctional door manager is designed for installation on a door header—that is, over and on one side (either entrance or exit, for example) of a door, which may be of generally any type, i.e. sliding, swinging, bifolding, low-energy or revolving. Also mounted on the base 8 are the appropriate power terminals and other connectors, not shown. Panel 9a is an infrared prism lens and shield 9b is transparent to microwave radiation.

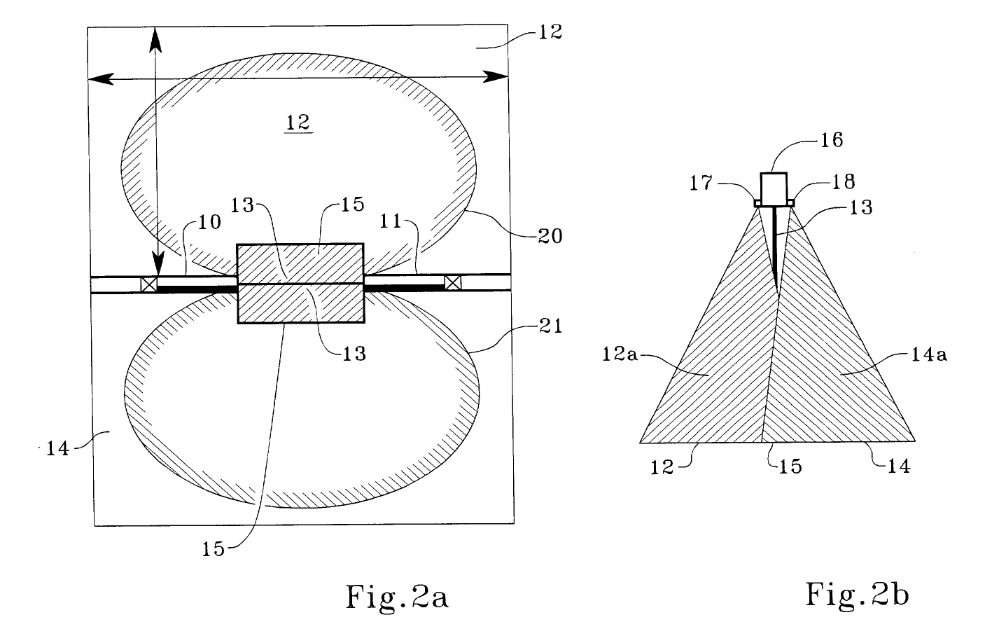

FIG. 2a is an overhead view of the floor area at the base of a sliding door having two moving parts 10 and 11 moved by mechanisms not shown which may be of any known type. Floor area 12 is sensed by camera 2 in a housing as depicted in FIGS. 1a and 1b mounted above the door plane 13 and on the same side as floor area 12. Floor area 14 is imaged in the same manner by the camera in a housing also similar to that of FIG. 1 mounted above the door on the same side of door plane 13 as floor area 14. The cameras in both housings are directed also to include in their sensing areas the central area 15. Thus it is seen that on each side of the door plane 13, the cameras monitor an area at least partly overlapping in the central area 15. The microwave transceivers or other motion detectors are directed to monitor areas 20 and 21, while the presence detectors oversee one or the other side of area 15.

The overlapping areas are illustrated again in FIG. 2b, which is a side view across door plane 13. The unitary, trifunctional sensing devices 17 and 18 are mounted on each side of door header 16. The shaded areas 12a and 14a represent the vertical sensing fields above floor areas 12 and 14, overlapping in central area 15, as shown in FIG. 2a.

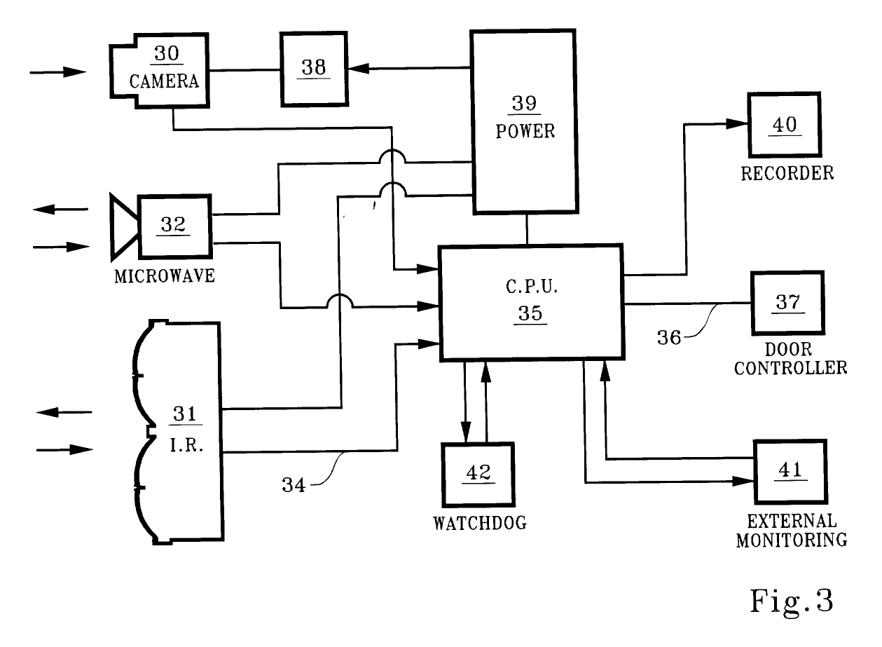

FIG. 3 is a block diagram of the interconnections of the three functions. The three functions are effected by the video camera 30 (camera 2 in FIG. 1, the infrared transceiver 31(item 4 in FIG. 1), and the microwave transceiver 32 (item 3 in FIG. 1). Microwave transceiver 32 preferably uses a Doppler effect hyper frequency planar antenna such as shown in U.S. design Pat. No. D436,546 titled “Planar Antenna,” further shown herein in FIG. 5. Power supply 39 serves all three functions—the video camera 30, which may have its own dedicated power supply 38, “active” infrared transceiver 31, and the microwave transceiver 32.

The infrared transceiver 31 operates in a known manner—that is, it generates infrared radiation which is reflected from objects in its predetermined surveillance area such as floor area 12 in FIG. 2a. The CPU 35 ascribes a “learned” background pattern of IR radiation to the “normal” status of the surveillance area. When an infrared-absorbing or reflecting object enters the surveillance area, the receiving components of the transceiver 31 generate an electrical output signal as a function of the new, different level of received infrared radiation in at least some portion of the target area. This signal is transmitted through connection 34 to the central processing unit (CPU) 35 which in turn generates a control signal transmitted through connection 36 to door controller 37. The door controller is connected to a motor and/or other devices (not shown) capable of moving the door. The CPU 35 is programmed so that if the IR-absorbing or reflecting object has just been detected, the door will open; preferably it is also programmed to cause the door to remain open during the period when one or more objects is/are detected and for an additional safety period.

The microwave transceiver 32 constantly transmits a low level microwave signal to the target area. The receiver portion of the transceiver will detect motion by the Doppler effect shift in the frequency of the reflected radiation, and generate an electrical signal as a function of the shift, sending the signal to CPU 35. The CPU 35 will in turn transmit a control signal in conformance with the overall programming in the CPU to either open the door or hold it open while motion continues to be detected, or close it at the end of a programmed time period after the discontinuance of detected motion. The signal to close the door may be overridden by the presence detection feature of the invention, as discussed above with respect to the infrared detection system.

Video or other camera 30, also energized by power supply 39, is, as explained above, directed at the surveillance area 12 or 14, with an overlap in area 15 (FIG. 2). The video camera 30 has a separate power supply 38, which may be controlled by the CPU 35. The “normal” position of the switch may be “on”, but CPU may be programmed to turn the camera off when there are no positive signals from either the infrared transceiver 31 or the microwave receiver 32. In this mode, as soon as motion or presence is detected, the camera activates. Alternatively, a separate recorder 40, which may be digital, tape or any other means of recording images from the camera, is turned on or off according to whether there is detectable presence or motion in the surveilled area. Images may be continuously transmitted to a terminal or coordinated surveillance system, whether or not recording is activated.

The recorder 40 includes a time marker so that the exact time of an event will be recorded along with the actual event captured by the camera.

An external monitoring device 41, which may also be called a “door check unit”, or DCU, is connected to the CPU 35. It is programmed to routinely check at least some of the individual components of the assembly to determine whether they are operating properly. The DCU may be programmed to periodically or intermittently test performance of the entire assembly; the assembly may be tested electronically after each door cycle, if desired. If in any case the DCU determines that there is a possible safety hazard due to a malfunction, it may cause the door to be fixed in the open or closed state, depending on the needs of the application. The DCU need not be mounted in the housing depicted in FIG. 1.

The “watchdog” feature of the invention depicted as block 42 may be an integral, or internal, part of the CPU 35 or embodied in a separate unit as shown. In either case it provides a program administered by its own clock for checking performance of the three functions to assure the independence and control parameters of the CPU are operating properly.

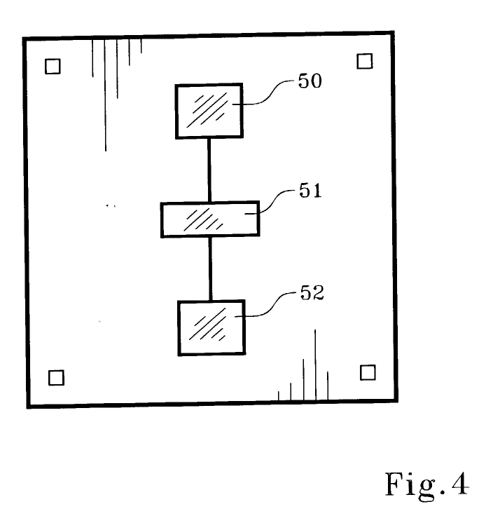

FIG. 4 is the planar antenna preferred for use in the microwave transceiver 32. It has patches 50, 51, and 52, as shown in U.S. Design Pat. No. D436,546. Any suitable waveguide may be used as is known in the art; filters are recommended for reducing the introduction of spurious radiation, as is also known in the art. The central patch 51 is shaped to be compatible with the waveguide, and the other two patches 50 and 52 have lengths optimized for resonance with the central frequency of the device. A horn may be used as a waveguide.

Our trifunctional door manager is useful for many types of doors—for example, sliding doors, swinging doors, bifold doors, low-energy doors, revolving doors, overhead doors, and sectional doors, large and small. As indicated above, two or more of the trifunctional units are readily adapted and programmed to operate interdependently.

1. Method of operating a door comprising, through an automatic control system, (a) opening and closing said door in response to a motion detection signal representing motion or the absence of motion in a predetermined area as detected by at least one motion detector, (b) opening or maintaining said door in the open position in response to a presence detection signal representing presence in said predetermined area, wherein said control system is programmed to override said motion detection signal by said presence detection signal to maintain said door in the open position, and (c) monitoring said predetermined area with an imaging device, said predetermined area including space on both sides of said door.

2. Method of claim 1 including an internal watchdog program having a dedicated clock for independently checking the functions (a), (b) and (c).

3. Method of claim 1 wherein said motion detector is a microwave transceiver.

4. Method of claim 1 wherein said motion detector is a passive infra red detector.

5. Method of claim 1 wherein said motion detector is an ultrasonic transceiver.

6. Method of claim 1 wherein said motion detector is an infrared transceiver.

7. Method of claim 1 wherein images are recorded from said imaging device.

8. Method of claim 1 wherein said imaging device is activated by either said motion detection signal or said presence detection signal, or by a control signal derived from either.

9. Method of claim 7 wherein said recording takes place remotely from said door, and said recording includes a time marker, and said recording is performed only when the door is open.

10. Method of claim 1 wherein said signal representing presence is generated from an infrared receiver.

11. Method of claim 10 wherein said infrared receiver is passive.

12. Method of claim 1 wherein said door is a sliding door.

13. Method of operating a door comprising (a) opening and closing said door in response to a signal representing motion or the absence of motion in a predetermined area as detected by a microwave transceiver mounted overhead of said door, (b) opening or maintaining said door in the open position in response to a signal representing presence in said predetermined area as determined by an infrared transceiver mounted overhead of said door, and (c) monitoring said predetermined area with an imaging device mounted overhead of said door, said predetermined area including space on both sides of said door.

14. Method of claim 13 wherein said microwave transceiver, said infrared transceiver, and said imaging device are enclosed in the same housing.

15. Apparatus for operating a door comprising a motion detector, a presence detector, and a video camera mounted in the same housing over a door, said motion detector, said presence detector and said video camera being activated to monitor substantially the same area on the ingress side of said door and including an area on the egress side of said door.

16. Apparatus of claim 15 wherein said motion detector is a microwave transceiver including a Doppler effect hyper frequency planar antenna.

17. Apparatus of claim 15 wherein said presence detector is an infrared transceiver.

18. Apparatus for operating a door comprising (a) a first microwave transceiver, a first infrared transceiver, and a first discreet video camera mounted in a first common housing over a first side of a door, said first microwave transceiver, said first infrared transceiver and said first video camera being activated to monitor an overlapping area on said first side of said door and including an overlapping area on a second side of said door and (b) a second microwave transceiver, a second infrared transceiver, and a second discreet video camera mounted in a second common housing over a second side of said door, said second microwave transceiver, said second infrared transceiver and said second video camera being activated to monitor at least one overlapping area on said second side of said door and including at least one overlapping area on said first side of said door.

19. Apparatus of claim 18 including means for opening, closing, and maintaining said door in the open position in response to said microwave transceivers and said infrared transceivers, and including means for remote recording of video data from said video cameras.

20. Method of ameliorating personal injury insurance rates of an enterprise which includes the automatic operation of at least one door, said method comprising (a) maintaining a detection system for a predetermined area on each side of said at least one door, said detection system comprising (i) a microwave motion detector (ii) an infrared presence detector and (iii) a video camera, (b) opening and closing said door as a function of presence and motion signals from said detection system, (c) recording images from said video camera including time markings on said images, and (c) automatically controlling (i) the video camera and (ii) the recording of images from the video camera as a function of presence and motion signals from said detection system.

21. Method of claim 22 including intermittently checking the performance of at least one of said microwave motion detector or said infrared presence detector.
